(19) United States
(12) Patent Application Publication
(10) Pub. No.: US 2005/0099335 A1
(43) Pub. Date: May 12, 2005

(54) MULTIPLE-FREQUENCY ANTENNA STRUCTURE

(76) Inventors: Shyh-Jong Chung, Hsin-Chu Hsien (TW); Ya-Ying Wang, Taipei City (TW); Min-Chuan Wu, Tai-Chung City (TW); Kuang-Yu Yen, Tai-Chung City (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,952

(22) Filed: Nov. 10, 2003

(51) Int. Cl. H01Q 1/38

(52) U.S. Cl. 343/700 MS; 343/702

(57) ABSTRACT

A multiple-frequency antenna includes a circuit board of dielectric material having a first surface and a second surface which is spaced apart from and is substantially parallel to the first surface, a ground plane layer of electrically conductive material covering a portion of the first surface of the circuit board, and a feed-line of electrically conductive material disposed on the second surface of the circuit board so as to extend over the ground plane layer. A first radiating element of electrically conductive material is disposed on the circuit board and electrically connected to the feedline. A second radiating element of electrically conductive material is disposed on the circuit board in close proximity to the first radiating element for coupling with the first radiating element, the coupling providing an electromagnetic feed to the second radiating element.

### BACKGROUND OF INVENTION

1. Field of the Invention

The present invention relates to a multiple-frequency antenna structure, and more specifically, to an antenna structure having a first radiating element coupling with a second radiating element.

2. Description of the Prior Art

The rapid development of the personal computer coupled with users' desires to transmit data between personal computers has resulted in the rapid expansion of local area networks. Today, the local area network has been widely implemented in many places such as in the home, public access areas, and the work place. However, the implementation of the local area network has been limited by its own nature. The most visible example of the limitation is the cabling. One solution to this problem is to provide personal computer with a wireless network interface card to enable the personal computer to establish a wireless data communication link. Using a wireless network interface card, a personal computer, such as a notebook computer, can provide wireless data transmission with other personal computers or with a host computing device such like a server connected to a conventional wireline network.

The growth in wireless network interface cards, particularly in notebook computers, has made it desirable to enable personal computers to exchange data with other computing devices and has provided many conveniences to personal computer users. As a key component of a wireless network interface card, the antenna has received much attention and many improvements, especially in function and size. FIG. 1 shows a PCMCIA wireless network interface card 8 used in a notebook computer. The card can be used with a PCMCIA slot built in a notebook computer. As shown, the wireless network interface card 8 comprises a main body 23, and an extension portion 12. The main body 23 further comprises driving circuitries, connectors, etc. The extension portion 12 comprises a printed antenna 10 for transmitting and receiving wireless signals. Presently, the antennas being used widely in a wireless network interface card include the printed monopole antenna, chip antenna, inverted-F antenna, and helical antenna. Among them, the printed monopole antenna is simple and inexpensive. As shown in FIG. 2, a printed monopole antenna 20 comprises a feed-line 21, a primary radiating element 22, a ground plane 24, and a dielectric material 25. The current on the printed monopole antenna is similar to current on a printed dipole antenna, so the electric field created will be the same. The difference is that the ground plane 24 of the printed monopole antenna 20 will create mirror current, so the total length of the printed monopole antenna 20 is only
λg/4,
which is half of the length of a printed dipole antenna. The improvement on the length of an antenna is significant in application for wireless network interface cards. The definition of the wavelength
λg
described above is

$${λ}_{ɛ} = \frac{1}{\sqrt{{ɛ}_{rc}}} * \frac{C}{{f}_{\dot{u}}}$$

Wherein
c
is the speed of light,
ƒ₀
is the center frequency of electromagnetic waves, and
ε_{nc}
is the equivalent dielectric constant and is between the nominal dielectric constant (around 4.4) of circuit board and the dielectric constant (around 1) of air. For example, if the center frequency is 2.45 GHz and the dielectric constant is 4.4, the length of the printed monopole antenna will be 2.32 cm. Since the space in a wireless network interface card reserved for an antenna is limited, an antenna with such length will not fit properly into a card, therefore, some modification for the antenna is required. In the U.S. Pat. No. 6,008,774 “Printed Antenna Structure for Wireless Data Communications”, modification for such antenna is disclosed. As shown in FIG. 3, the shape of a printed monopole antenna 30 has been changed in order to reduce the size thereof. The concept of U.S. Pat. No. 6,008,774 is to bend the primary radiating element 22 of FIG. 2 into the form of a V-shaped primary radiating element 32 as shown in FIG. 3. Although the overall length of the primary radiating element 32 of U.S. Pat. No. 6,008,774 is still
λg/4,
however, the space needed for furnishing this modified primary radiating element 32 is reduced. The antenna 30 shown in FIG. 3 also comprises a feed-line 31, the primary radiating element 32, a ground plane 34, and a dielectric material.

### SUMMARY OF INVENTION

It is therefore a primary objective of the claimed invention to provide a multiple-frequency antenna in order to solve the above-mentioned problems.

According to the claimed invention, a multiple-frequency antenna includes a circuit board of dielectric material having a first surface and a second surface which is spaced apart from and is substantially parallel to the first surface, a ground plane layer of electrically conductive material covering a portion of the first surface of the circuit board, and a feed-line of electrically conductive material disposed on the second surface of the circuit board so as to extend over the ground plane layer. A first radiating element of electrically conductive material is disposed on the circuit board and electrically connected to the feed-line. A second radiating element of electrically conductive material is disposed on the circuit board in close proximity to the first radiating element for coupling with the first radiating element, the coupling providing an electromagnetic feed to the second radiating element.

It is an advantage of the claimed invention that the second radiating element couples with the first radiating element. This characteristic allows the multiple-frequency antenna to be built in a variety of different arrangements, and provides flexibility in the design of the antenna. Moreover, since the coupling provides an electromagnetic feed to the second radiating element, the first and second radiating elements serve to respectively generate first and second operating frequencies of the multiple-frequency antenna.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram showing a conventional wireless network interface card.

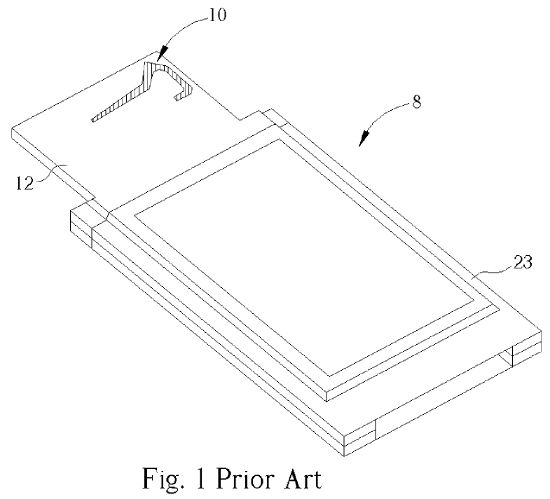

FIG. 2 is a schematic diagram showing a conventional Printed Monopole Antenna.

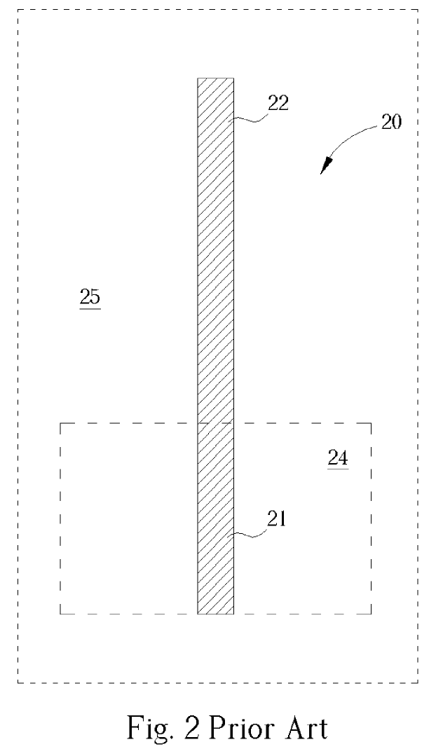

FIG. 3 is a schematic diagram showing a conventional printed monopole antenna of U.S. Pat. No. 6,008,774.

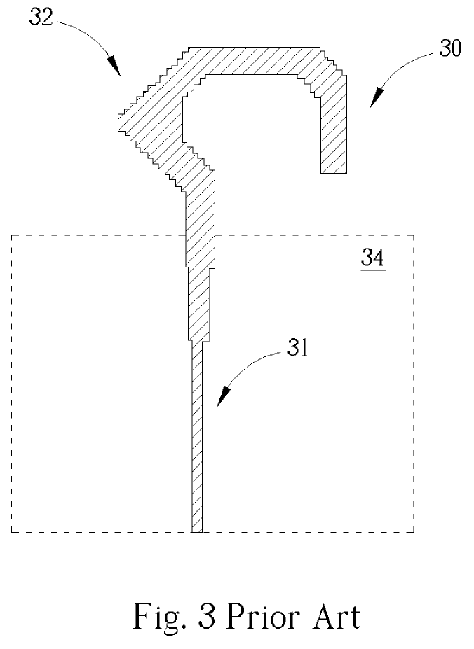

FIG. 4 is a top view diagram showing a multiple-frequency antenna according to a first embodiment of the present invention.

FIG. 5 is a perspective diagram of the antenna showing a layered arrangement of the antenna.

FIG. 6 is a cross-sectional view of the antenna taken at line A-A″ in FIG. 4.

FIG. 7 is a top view diagram showing a multiple-frequency antenna according to a second embodiment of the present invention.

FIG. 8 is a plot diagram showing a relationship between measured return loss and frequency of the antenna according to the present invention.

### DETAILED DESCRIPTION

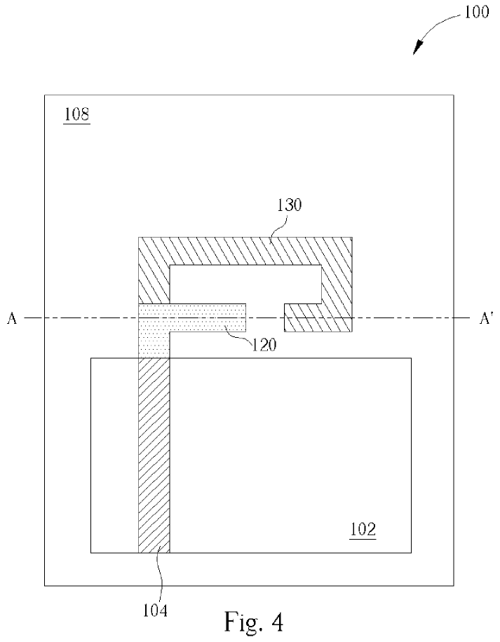

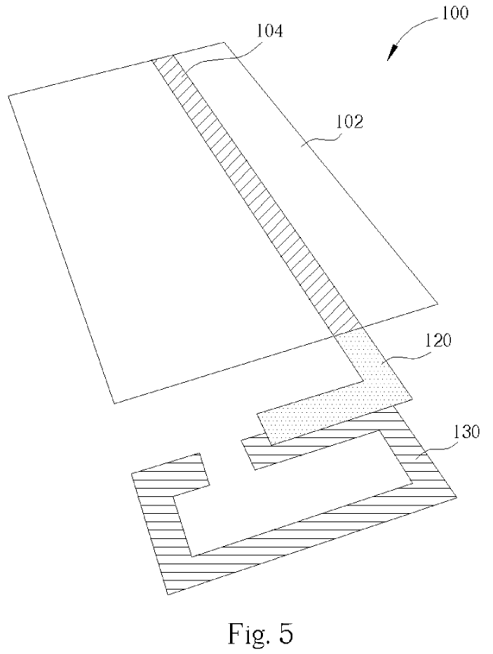

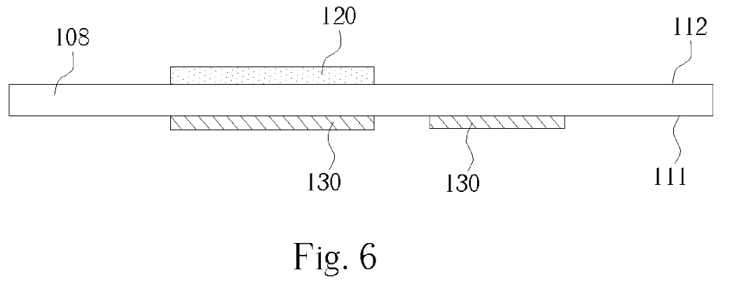

Please refer to FIGS. 4 to 6. FIG. 4 is a top view diagram showing a multiple-frequency antenna 100 according to a first embodiment of the present invention. FIG. 5 is a perspective diagram of the antenna 100 showing a layered arrangement of the antenna 100. FIG. 6 is a cross-sectional view of the antenna 100 taken at line A-A″ in FIG. 4. As shown, a feed-line 104 is provided for receiving and transmitting wireless signals. The antenna 100 is formed on a dielectric layer 108 (for example, a circuit board made of dielectric material). As shown in FIG. 6, the dielectric layer 108 contains a first surface 111 and a second surface 112. The first and second surfaces 111 and 112 are spaced apart from and are substantially parallel to each other. A ground plane layer 102 covers some portion of the first surface 111 of the dielectric layer 108. The feed-line 104 is on the second surface 112 of the dielectric layer 108 and extends over the ground plane layer 102. One end of the feed-line 104 is electrically connected to driving circuitry (not shown in figures).

The antenna 100 contains a first radiating element 120 electrically connected to the feed-line 104 for serving to generate a first operating frequency of the antenna 100. The first radiating element 120 is preferably a monopole antenna, and a length of the first radiating element 120 is approximately one-quarter wavelength of the first operating frequency of the antenna 100.

In addition, the antenna 100 also contains a second radiating element 130 for serving to generate a second operating frequency of the antenna 100. As shown in FIGS. 4 to 6, the first radiating element 120 is disposed on the second surface 112 and the second radiating element 130 is disposed on the first surface 111 of the dielectric layer 108. The second radiating element 130 is not directly connected to the feed-line 104. Instead, at least one portion of the second radiating element 130 is positioned in close proximity to a portion of the first radiating element 120 to establish coupling between the first and second radiating elements 120 and 130. The coupling provides an electromagnetic energy to feed to the second radiating element 130, and enables the second radiating element 130 to generate a second operating frequency of the antenna 100. The second radiating element 130 is preferably an open-loop resonator antenna, and a length of the second radiating element 130 is approximately one-half wave-length of the second operating frequency of the antenna 100. As shown in FIG. 6, the second radiating element 130 is disposed on the first surface 111 of the dielectric layer 108, and a portion of the second radiating element 130 overlaps with a portion of the first radiating element 120 that is disposed on the second surface 112. It should be noted that other arrangements of the first and second radiating elements 120 and 130 are possible. For instance, the first and second radiating elements 120 and 130 may be disposed on the same surface or different surfaces of the dielectric layer 108, so long as the first radiating element 120 is close enough to the second radiating element 130 to establish the energy coupling. The feed-line 104, the first radiating element 120, and the second radiating element 130 are all made of electrically conductive material.

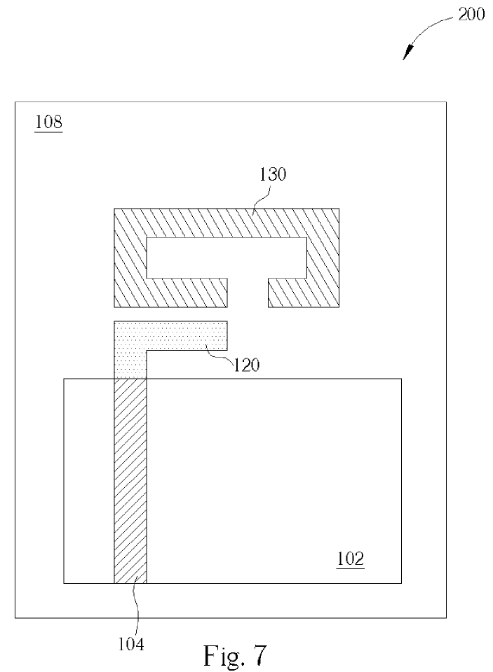

Please refer to FIG. 7. FIG. 7 is a top view diagram showing a multiple-frequency antenna 200 according to a second embodiment of the present invention. In the antenna 200, the first radiating element 120 and the second radiating element 130 are both disposed on the second surface 112 of the dielectric layer 108. Again, the main requirement in any embodiment of the present invention is that a portion of the second radiating element 130 is in close proximity to a portion of the first radiating element 120, so as to allow the energy coupling to take place.

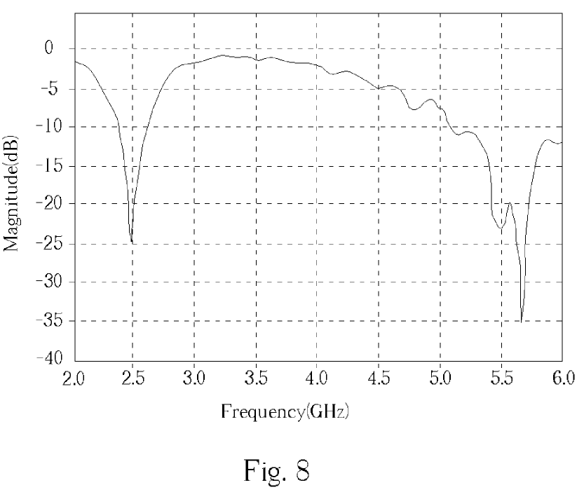

Please refer to FIG. 8. FIG. 8 is a plot diagram showing a relationship between measured return loss and frequency of the antenna 100 according to the present invention. In FIG. 8, the first operating frequency produced by the first radiating element 120 has a frequency centered at approximately 5.5 GHz. The corresponding frequency band having a magnitude of 10 dB ranges from 5.05 to 6.02 GHz. The second operating frequency produced by the second radiating element 130 has a frequency centered at approximately 2.45 GHz. The corresponding frequency band having a magnitude of 10 dB ranges from 2.35 to 2.6 GHz.

The antenna disclosed in the embodiments of the present invention contains two radiating elements for generating first and second operating frequencies. The first radiating element couples with the second radiating element to provide an electromagnetic energy to feed to the second radiating element. Because coupling is involved, and the second radiating element does not have to be directly connected to the feed-line, greater flexibility is achieved in designing the antenna.

Those skilled in the art will readily observe that numerous modifications and alterations of the device may be made while retaining the teachings of the invention. Accordingly, the above disclosure should be construed as limited only by the metes and bounds of the appended claims.

1. An antenna, comprising:
a dielectric layer having a first surface and a second surface which is spaced apart from and is substantially parallel to the first surface;
a ground layer of electrically conductive material covering a portion of the first surface of the dielectric layer;
a feed-line of electrically conductive material disposed on the second surface of the dielectric layer;
a first radiating element of electrically conductive material disposed on the dielectric layer and electrically connected to the feed-line, wherein the first radiating element is for generating a first operating frequency of the antenna; and
a second radiating element of electrically conductive material disposed on the dielectric layer in close proximity to the first radiating element such that an electromagnetic energy can be transformed from the first radiating element to the second radiating element through energy coupling, wherein the second radiating element is for generating a second operating frequency of the antenna.

2. The antenna of claim 1 wherein the first and second radiating elements are both disposed on a same surface of the circuit hoard dielectric layer.

3. The antenna of claim 1 wherein the first and second radiating elements are disposed on different surfaces of the dielectric layer.

4. The antenna of claim 3 wherein the first radiating element is disposed on the second surface of the dielectric layer, and the second radiating element is disposed on the first surface of the dielectric layer.

5. The antenna of claim 4 wherein at least a portion of the first radiating element disposed on the second surface of the dielectric layer is in close proximity to at least a portion of the second radiating element disposed on the first surface of the dielectric layer.

6. The antenna of claim 1 wherein the first radiating element is a monopole antenna.

7. The antenna of claim 1 wherein the second radiating element is a half-wavelength resonator.

8. An antenna, comprising:
a circuit board having a first surface and a second surface which is spaced apart from and is substantially parallel to the first surface;
a ground layer covering a portion of the first surface of the circuit board;
a feed-line disposed on the second surface of the circuit board;
a first radiating element of electrically conductive material disposed on the circuit board and electrically coupled to the feed-line, wherein the first radiating element is for generating a first operating frequency of the antenna; and
a second radiating element of electrically conductive material disposed on the circuit board in close proximity to the first radiating element such that an electromagnetic energy can be transformed from the first radiating element to the second radiating element through energy coupling, wherein the second radiating element is for generating a second operating frequency of the antenna.

9. The antenna of claim 8 wherein the circuit board is composed of dielectric material.

10. The antenna of claim 8 wherein the first and second radiating elements are both disposed on a same surface of the circuit board.

11. The antenna of claim 8 wherein the first and second radiating elements are disposed on different surfaces of the circuit board.

12. The antenna of claim 8 wherein at least a portion of the first radiating element disposed on the second surface of the circuit board is in close proximity to at least a portion of the second radiating element disposed on the first surface of the circuit board.

13. The antenna of claim 8 wherein the first radiating element is a monopole antenna.

14. The antenna of claim 8 wherein the second radiating element is a half-wavelength resonator.

15. An antenna, comprising:
a dielectric layer;
a feed-line disposed on the dielectric layer;
a first radiating element disposed on the dielectric layer and electrically connected to the feed-line for generating a first radio signal at a frequency of about 5.5 GHz; and
a second radiating element disposed on the dielectric layer;
wherein electromagnetic energy is coupled from the first radiating element to the second radiating element, so that the second radiating element generates a second radio signal at a frequency of about 2.45 GHz.

16. The antenna of claim 15, wherein the antenna is attached to a wireless LAN (WLAN) device.

17. The antenna of claim 15, further comprising:
a ground layer covering at least a portion of a surface of the dielectric layer.

18. The antenna of claim 15, wherein the dielectric layer has a first surface and a second surface.

19. The antenna of claim 18, wherein the first surface and the second surface of the dielectric layer are substantially parallel to each other.

20. The antenna of claim 18, wherein the first radiating element and the second radiating element are both disposed on the first surface of the dielectric layer.

21. The antenna of claim 18, wherein the first radiating element is disposed on the first surface of the dielectric layer, and the second radiating element is disposed on the second surface of the dielectric layer.

22. The antenna of claim 15, wherein the first radiating element is a monopole antenna.

23. The antenna of claim 15, wherein the second radiating element is a half-wavelength resonator.
